(19) United States
(12) Patent Application Publication
(10) Pub. No.: US 2010/0007199 A1
(43) Pub. Date: Jan. 14, 2010

(54) BRAKE SYSTEM FOR VEHICLE

(75) Inventor: Joo Gon KIM, Gyeonggi-do (KR)

Correspondence Address: LADAS & PARRY, 5670 WILSHIRE BOULEVARD, SUITE 2100, LOS ANGELES, CA, 90036-5679, US

(73) Assignee: MANDO CORPORATION, Gyeonggi-do (KR)

(21) Appl. No.: 12/501,731

(22) Filed: Jul. 13, 2009

(30) Foreign Application Priority Data
Jul. 14, 2008 (KR) 10-2008-68154

(51) Int. Cl. B60T 13/74

(52) U.S. Cl. 303/3

(57) ABSTRACT

A brake system for a vehicle is disclosed. The brake system has a dual electronic control unit that classifies electromechanical brake units into two groups. When a vehicle is not smoothly braked due to an error generated in the electro-mechanical brake unit of either of two groups, the brake system smoothly brakes the vehicle using the other electromechanical brake unit having no error. The system includes a pedal, a pedal position detection sensor detecting a moving distance of the pedal when a driver presses the pedal, an electromechanical brake unit to provide each wheel with electrical braking force in response to the pedal's moving distance detected, and a dual electronic control unit to divide the electromechanical brake unit providing each wheel with the electrical braking force into two groups, and brake the vehicle by the electromechanical brake unit of each group.

### CROSS-REFERENCE TO RELATED APPLICATION(S)

This application claims the benefit of Korean Patent Application No. 2008-0068154, filed on Jul. 14, 2008 in the Korean Intellectual Property Office, the disclosure of which is incorporated herein by reference.

### BACKGROUND

1. Field

Embodiments of the present invention relate to a vehicle brake system for controlling not only front wheels but also rear wheels of a vehicle using motors.

2. Description of the Related Art

Generally, a brake system mounted to a vehicle that obtains a braking force by partially pressing frictional pads against opposite sides of a circular disk rotating along with each wheel of a vehicle.

The brake system is classified into a hydraulic brake system (HBS) to obtain a braking force through a hydraulic pressure and an electromechanical brake (EMB) to obtain a braking force through an electrical rotating force of each motor.

In this case, the HBS gives pressure to brake oil along a hydraulic line so as to transfer the brake oil to a wheel cylinder of front wheels or rear wheels, so that it brakes each wheel. The EMB brakes each wheel by the rotating force generated from each motor.

Herein, the EMB need not have a duration time required for transmission of such hydraulic pressure, optimally controls the vehicle braking force, and is freely mounted to the vehicle brake system such that many people and developers are conducting intensive research into the EMB as a substitute for the HBS.

However, provided that an unexpected error occurs in each motor or any electrical system of a vehicle such that the vehicle comes to a sudden stop, the EMB has difficulty in correctly controlling each motor, so that the smooth braking of the vehicle is not performed.

### SUMMARY

Therefore, it is an aspect of the present invention to provide a vehicle brake system having a dual electronic control unit that classifies electromechanical brake units into two groups, so that the vehicle brake system, when a vehicle is not smoothly braked due to an error generated in the electromechanical brake unit of either of the two groups, smoothly brakes the vehicle using the other electro-mechanical brake unit having no error.

Additional aspects of the invention will be set forth in part in the description which follows and, in part, will be obvious from the description, or may be learned by practice of the invention.

In accordance with one aspect of the present invention, a brake system for a vehicle includes a pedal, a pedal position detection sensor to detect a moving distance of the pedal when a driver presses the pedal, an electromechanical brake unit to provide each wheel with electrical braking force in response to the pedal's moving distance detected by the pedal position detection sensor, and a dual electronic control unit to divide the electromechanical brake unit providing each wheel with the electrical braking force into two groups, and brake the vehicle by the electro-mechanical brake unit of each group.

When an error occurs in an electromechanical brake unit belonging to either of the two groups, the dual electronic control unit may brake the vehicle by an electromechanical brake unit belonging to the other group having no error.

The dual electronic control unit may include a current detection sensor to measure an electrical braking force provided from a motor of the electromechanical brake unit.

The dual electronic control unit may determine the presence or absence of an error in the electromechanical brake unit according to a current value detected by the current detection sensor.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram illustrating a vehicle brake system according to an exemplary embodiment; and

FIG. 2 is a flow chart illustrating a method for controlling a vehicle brake system according to an exemplary embodiment.

### DETAILED DESCRIPTION

Reference will now be made in detail to the embodiments of the present invention, examples of which are illustrated in the accompanying drawings, wherein like reference numerals refer to like elements throughout.

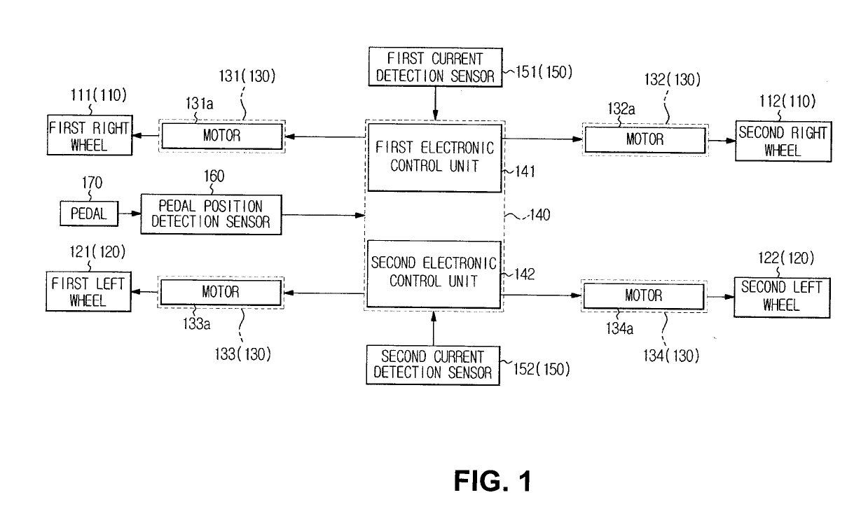

FIG. 1 is a block diagram illustrating a vehicle brake system according to an exemplary embodiment.

Referring to FIG. 1, a vehicle brake system according to an embodiment of the present invention includes right wheels 110, left wheels 120, a pedal 170 on which pressure is applied by a driver's intention of braking, a pedal position detection sensor 160 for detecting a moving distance of the pedal 170 according to the pressure applied to the pedal 170, an electromechanical brake unit 130 for performing a brake control of respective right wheels 111 and 112 and respective left wheels 121 and 122, a first electronic control unit 141 for controlling electro-mechanical brake units 131 and 132 used for braking the right wheels 111 and 112, a second electronic control unit 142 for controlling electro-mechanical brake units 133 and 134 used for braking the left wheels 121 and 122, a first current detection sensor 151 for detecting errors of the electromechanical brake units 131 and 132 used for braking the right wheels 111 and 112, and a second current detection sensor 152 for detecting errors of the electromechanical brake units 133 and 134 used for braking the left wheels 121 and 122.

If the pedal 170 moves by a driver, the pedal position detection sensor 160 detects a moving distance of the pedal 170 and transmits the detected moving distance to the electronic control unit 150.

The electromechanical brake unit 130 performs a brake control of each right wheel 111 or 112 and each wheel 121 or 122. Upon receiving the pedal 170's moving distance detected by the pedal position detection sensor 160 from the first and second electronic control units 141 and 142, the electromechanical brake unit 130 rotates motors 131a, 132a, 133a, and 134a to generate a braking pressure corresponding to the received moving distance. Herein, respective electro-mechanical brake units 131, 132, 133, and 134 include motors 131a, 132a, 133a, and 134a to generate electrical rotating force, respectively. Further, the electro-mechanical brake units 131, 132, 133, and 134 include a booster to increase the rotating force generated from motors 131a, 132a, 133a, and 134a, a nut member to convert the rotating force of the booster into the rectilinear motion, and a frictional pad being connected to a disk in response to forward or backward movement of the rectilinearly-moving nut member.

The first current detection sensor 151 detects each current signal generated from motors 131a and 132a of the electromechanical brake units 131 and 132 for brake controls of right wheels 111 and 112. The second current detection sensor 152 detects each current signal generated from motors 133a and 134a of the electro-mechanical brake units 133 and 134 for brake controls of left wheels 121 and 122.

The first and second electronic control units 141 and 142 determine the presence or absence of an error in the electro-mechanical brake units 131 and 132 for brake controls of right wheels 111 and 112 or the presence or absence of an error in the electromechanical brake units 133 and 134 for brake controls of left wheels 121 and 122 according to values of current signals detected by the first and second current detection sensors 151 and 152, such that they perform a brake control using the electromechanical brake unit 130 having no error. For example, if it is determined that an error has occurred in the electromechanical brake units 131 and 132 for brake controls of the right wheels 111 and 112, the first and second electronic control units 141 and 142 smoothly brake the left wheels 121 and 122 having no errors using the electromechanical brake units 133 and 134 used for brake controls of the left wheels 121 and 122.

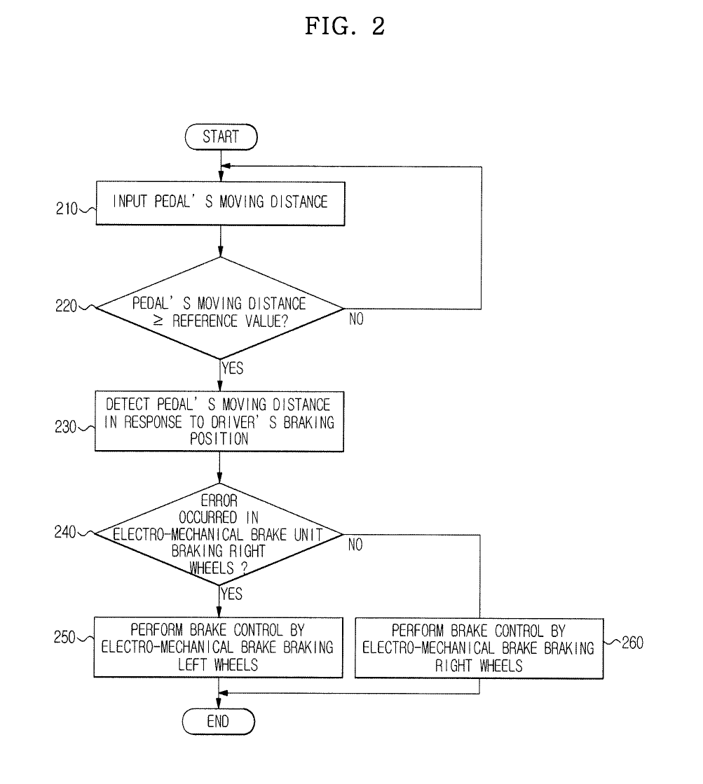

FIG. 2 is a flow chart illustrating a method for controlling a vehicle brake system according to an exemplary embodiment.

Referring to FIG. 2, if a driver presses the pedal 170, the pedal position detection sensor 170 detects the moving distance of the pedal 170, and the detected moving distance is input to the first electronic control unit 141 at operation 210.

Thereafter, the pedal 170's moving distance input to the first electronic control unit 141 is compared with a predetermined reference value at operation 220. In the case where the pedal moving distance is equal to or higher than the reference value, it is determined that the pedal 170 has moved by a driver's intention of braking at operation 230. Meanwhile, if the pedal 170's moving distance is less than the predetermined reference value at operation 220, the operation program returns to the operation 210, so that the moving distance of the pedal 170 is re-input to the first electronic control unit 141 at operation 210.

After that, the first electronic control unit 141 determines the presence or absence of an error in the electromechanical brake units 131 and 132 for brake controls of right wheels 111 and 112 at operation 240.

If it is determined that the error has occurred in the electromechanical brake units 131 and 132 for brake controls of the right wheels 111 and 112 at operation 240, the brake control is carried out by the electromechanical brake units 133 and 134 for brake controls of the left wheels 121 and 122 at operation 250. Otherwise, if it is determined that no error has occurred in the electromechanical brake units 131 and 132 for brake controls of the right wheels 111 and 112 at operation 240, the brake control is carried out by the electromechanical brake units 131 and 132 for brake controls of the right wheels 111 and 112 at operation 260.

The above-mentioned method for controlling the vehicle brake system is equally carried out in not only the first electronic control unit 141 but also the second electronic control unit 142. That is, the control method checks the pedal 170's moving distance in response to the driver's intention of braking, and determines the presence or absence of an error in the electromechanical brake units 133 and 134 used for brake controls of the left wheels 121 and 122. If it is determined that the error has occurred in the electromechanical brake units 133 and 134, the brake control is carried out by the electromechanical brake units 131 and 132 used for brake controls of the right wheels 111 and 112.

As shown in the above-mentioned embodiment, although the electronic control unit 140 is divided into a first electronic control unit 141 to control electro-mechanical brake units 131 and 132 for a brake control of right wheels 111 and 112 and a second electronic control unit 142 to control electromechanical brake units 133 and 134 for a brake control of left wheels 121 and 122 for convenience of description and better understanding of the embodiment, the reference of forming such groups by dividing the electronic control unit 140 is not limited thereto. For example, the electronic control unit 140 may be divided into a first electronic control unit to control the electromechanical brake units for the brake control of front wheels and a second electronic control unit to control the electromechanical brake units for the brake control of rear wheels. For another example, the electronic control unit 140 may be divided into a first electronic control unit to control the electro-mechanical brake units for a brake control of the first front wheel and the second rear wheel and a second electronic control unit to control the electromechanical brake units for a brake control of the second front wheel and the first rear wheel.

As is apparent from the above description, a vehicle brake system according to an embodiment of the present invention includes a dual electronic control unit that classifies the electromechanical brake units for braking respective wheels into two groups. As a result, although a vehicle is not smoothly braked due to an error generated in the electromechanical brake unit of either of the two groups, the vehicle brake system smoothly brakes the vehicle using the electromechanical brake unit belonging to the other group having no error, so that the reliability of a vehicle brake control increases even though there arises an unexpected error due to an electrical wiring defect or mechanical defect.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A brake system for a vehicle comprising:
a pedal;
a pedal position detection sensor to detect a moving distance of the pedal when a driver presses the pedal;
an electromechanical brake unit to provide each wheel with electrical braking force in response to the pedal's moving distance detected by the pedal position detection sensor; and
a dual electronic control unit to divide the electromechanical brake unit providing each wheel with the electrical braking force into two groups, and brake the vehicle by the electromechanical brake unit of each group.

2. The brake system according to claim 1, wherein, the dual electronic control unit, when an error occurs in an electromechanical brake unit belonging to either of the two groups, brakes the vehicle by an electromechanical brake unit belonging to the other group having no error.

3. The brake system according to claim 2, wherein the dual electronic control unit includes a current detection sensor to measure an electrical braking force provided from a motor of the electromechanical brake unit.

4. The brake system according to claim 3, wherein the dual electronic control unit determines the presence or absence of an error in the electro-mechanical brake unit according to a current value detected by the current detection sensor.
